(19) United States
(12) Patent Application Publication
(10) Pub. No.: US 2010/0159167 A1
(43) Pub. Date: Jun. 24, 2010

(54) PEELABLE SHEET FOR FIBROUS SUBSTRATES

(75) Inventor: Rainer SCHUMACHER, Seebruck (DE)

Correspondence Address: Fanelli Strain & Haag PLLC, 1455 Pennsylvania Ave., N.W., suite 400, Washington, DC, 20004, US

(73) Assignee: Alkor Folien GmbH

(21) Appl. No.: 12/643,991

(22) Filed: Dec. 21, 2009

(30) Foreign Application Priority Data
Dec. 23, 2008 (DE) 10 2008 063 024.1
Jan. 28, 2009 (DE) 10 2009 006 470.2

(51) Int. Cl. B32B 1/02; B32B 27/08; B32B 5/00; B32B 27/06; B32B 27/10

(52) U.S. Cl. 428/34.3; 428/516; 428/517; 428/220; 428/513; 428/34.2; 428/35.2; 428/35.7

(57) ABSTRACT

The present invention relates to a polypropylene sheet having a peeling layer that is well-suited to bond detachably to coated or uncoated fibrous substrates. The peeling layer comprises a combination of polypropylene, preferably between 20% and 70%, and a polyolefinic plastomer having a density of 0.85 to 0.89 g/cm³, preferably between 30 and 80%, that meets this requirement without further additives such as bonding enhancers, inorganic fillers or polar polymers.

The present invention relates to a sheet that can be used together with a coated or uncoated paper or a coated or uncoated synthetic paper to produce a peelable and sterilizable connection by means of a heat-sealing process, and a peelable composite made of said sheet and a coated or uncoated paper or a coated or uncoated synthetic paper, as well as the use thereof for the production of sterilizable packaging.

Composites are used for packaging of medical articles such as swabs, syringes, drapes, surgical sets, see, e.g., DE 19 27 746 A1, DE 8706916 U1. The composites usually consist of a substrate, often in the form of a base sheet, and a top sheet. The bonding between top and base sheet must be good enough for said bond not to come apart during transport and for the packaged and sterilized material to be protected, but must also be “peelable” to open it with a certain force when in use. One particular requirement in this context is that the force for separation must not be so high as to tear-out fibers.

The substrate to be heat-sealed usually consists of a paper, a synthetic paper, such as, e.g., Tyvek® (DuPont) or Ovantex® (Oliver), or a synthetic paper that has been provided with a coating. These substrates ensure that the gas can enter into the packaging during sterilization, e.g. using ethylene oxide, and that the pathogens are killed therein.

Substrates that are coated usually have the coating applied such that gases can still permeate through this material through small defect sites. Application DE 19 27 746 A1 describes papers that are coated in the form of a grid pattern such that the gases can permeate through the paper, while safe closure of the container can still be ensured. Coating materials used in this context include LLDPE (linear low density polyethylene), functionalized copolymers such as, for example, EVA (ethylene vinylacetate) or EEA (ethylene ethylacrylate) or EBA (ethylene butylacrylate). It is disadvantageous in this case that uneven sites in the substrate are transferred to the coating.

Uncoated substrates use top sheets that are provided with a peeling layer. In this context, the peeling layer ensures the bonding to the substrate and the ability to be separated by hand for opening.

The literature describes very different systems. For example, sheets made of coated polyester or polyamide are known. Predominantly, a polyethylene layer is applied here by means of extrusion coating.

WO 86/03976 A1 describes a packaging system that consists of a gas-permeable side and a peelable sheet. Said peelable sheet is made up of a polyester, nylon or polycarbonate, and an EVA layer.

U.S. Pat. No. 4,810,541 A describes a packaging container that contains a peeling layer made of a mixture of polyethylene, EVA, and polybutylene.

U.S. Pat. No. 3,891,089 A describes that substrates with specially selected EVA polymer layers heat-seal to paper under defined conditions and are well-suited for peelable packaging.

WO 03/091020 A1 describes a peeling sheet that consists of at least 2 layers. The main layer consists of polyethylene having a density of 0.88 to 0.93 g/cm³ and the peeling layer consists of a mixture of polyethylene and a mineral filler as peeling force regulating substance and, if applicable, a polyolefin plastomer. Said peeling layer adheres to synthetic papers such as, e.g., Tyvek®. However, the filler does not allow for the packaging to be transparent.

U.S. Pat. No. 5,830,547 A describes a peeling layer that consists of EVA and EAA polymers, whereby the high peeling forces of this mixture, that would lead to tearing of fibers, are kept under control by admixture of polybutene and talcum.

It was the object of the present invention to provide a sheet that is well-suited as top sheet for packaging of this type, and is transparent and can consist of pure polyolefin material.

Surprisingly, it was found that a sheet comprising at least two layers, namely a peeling layer made of a mixture of polypropylene and a polyolefin plastomer that can be heat-sealed to a substrate made of coated or uncoated paper or synthetic paper such that a sealing seam with a peeling force of 0.8 to 2.8 N/cm is obtained, and a main layer made of polypropylene having a heat resistance of up to at least 130° C., meets the object specified above.

Accordingly, the present invention relates to a sheet made of at least 2 layers, preferably 3 layers, that has preferably been produced by means of a coextrusion in one step to have the following structure:

2-layer sheet: main layer, peeling layer
3-layer sheet: cover layer, core or main layer, peeling layer.

In the context of the present invention, the term, “sheet”, shall be understood to mean planar structures whose width and length exceeds their thickness by many-fold. Usually, the thickness is less than one millimeter to a few micrometers.

Unless specified otherwise, a sheet can be mono-layered or multi-layered, e.g. two-, three- or four-layered. The individual layers or leafs can be manufactured by calendering, extrusion, coextrusion, extrusion coating and/or bonded by various laminating procedures such as bonding, thermal bonding, and similar technique. The connection in laminating extends over the entire or essentially the entire surface.

The sheet according to the invention comprises a peeling layer that is well-suited to form a detachable adhesive bond with coated or uncoated fibrous substrates. The special feature of the peeling layer is a combination of polypropylene, preferably between 20 and 70%, and a polyolefinic plastomer having a density of 0.85 to 0.89 g/cm³, preferably between 30 and 80%, that meets the specified requirements without having further additives such as bonding enhancers, inorganic fillers or polar polymers added to it.

The main layer consists of a flexible, perforation-resistant, but thermally deformable mixture of polypropylenes and, if applicable, other polyolefins and/or additives and processing aids. Depending on the deformation requirements, polypropylene copolymers, random-block-copolymers or SEBS (styrene-ethylene-butylene-styrene polymers), SBS (styrene-butadiene-styrene polymers, styrene-isoprene-styrene polymers (SIS), styrene-ethylene-butylene-styrene polymers (SEBS), styrene-ethylene-propylene-styrene polymers (SEPS) or comparable components can be selected and admixed.

It is preferred to use for the main layer mixtures of polypropylenes based on random copolymers, heterophasic random copolymers and homopolymers in order to ensure optimized basic properties depending on the existing requirements, such as deep-drawing ability and perforation resistance. It is feasible to use just a single polypropylene (homo- or copolymer).

In the context of the present invention, the term, “based on”, when referring to the composition of sheets and/or sheet layers shall be understood to mean that said sheet or sheet layer essentially consists of said polymer or said polymer mixture, whereby common additives, fillers, etc., in the known amounts each and a minor fraction of up to 30 wt-%, usually no more than 20 wt-%, and in particular no more than 10 wt-%, of other polymers may be added. Specifically, no other polymers (other than, e.g., production-related impurities) are contained therein.

Unless specified otherwise, the term, polymer, comprises homo- and copolymers as well as mixtures of two or more polymers. Polymers usually have a molecular mass of at least 10,000, typically of several 10,000 to several 100,000 g/mol. Copolymers can, e.g., be statistical, alternating, block and graft copolymers.

Typical polypropylenes for the main layer are those with MFI values in the range of 1 to 12 g/10 min at 230° C. Typical representatives include, for example, RD 204 CF, RD 208 CF, SD 233 CF (Borealis) or 525 P (Sabic). They can be either homo- or copolymers, with copolymers being preferred. Copolymers of polypropylene preferably contain alpha-olefins as comonomers, such as, e.g., ethylene, 1-butene, 1-pentene, 4-methyl-1-pentene, 1-hexene, 1-heptene or 1-octene, or a mixture thereof. The content of comonomers can be in the range of 0.2% to 12% in the case of ethylene, from 0.2% to 15% in the case of 1-butene, and from 0.2% to 40% in the case of 1-octene.

Increased perforation resistance can also be attained by adding ultra-low-density polyethylene (ULDPE), linear low-density polyethylene (LLDPE) or styrene-butadiene-styrene polymers (SBS), styrene-isoprene-styrene polymers (SIS), styrene-ethylene-butylene-styrene polymers (SEBS) and/or styrene-ethylene-propylene-styrene polymers (SEPS). As a rule, the quantities of these polymers used are between 10 and 40 wt-%. For example, the Kraton grades G1643, G1654 G1657, G1726, are well-suited. The grades, Dowlex SC2107, SC2108 or Attana 4606, 4607 of Dow Chemicals can be used as ULDPE or LLDPE.

The peeling layer consists of 20 to 70 wt-% polypropylene and 30 to 80 wt-% polyolefinic plastomer having a density of 0.85 to 0.89 g/cm³, as well as, if applicable, up to 10% processing aids and additives such as antioxidants, UV stabilizers, UV absorbers, lubricants, anti-blocking agent, and similar substances.

The term, polyolefinic plastomer, shall be understood to mean, in particular, ethylene alpha-olefin copolymers containing one or more alpha-olefin comonomers. Typical comonomers are alpha-olefins with 4 to 8 C-atoms, preferably 1-butene, 1-hexene or 1-octene. The density of the polyolefinic plastomers is typically in the range of 0.860 g/cm³ to 0.91 g/cm³. The melting index can be between 0.5 and 30 g/10 min at 190° C. The production of polymers of this type is described, e.g., in patents EP 0461815, U.S. Pat. No. 5,278,236, EP 0273654. Typical representatives are, for example: Affinity EG 8200 (Dow Chemicals, D=0.873 g/cm³, MFI=4.5 g/10 min, 190° C./2.16 kg), Affinity EG 8150 (Dow Chemicals, D=0.868 g/cm³, MFI=0.5 g/10 min, 190° C./2.16 kg), Affinity EG 8400 (Dow Chemicals, D=0.87 g/cm³, MFI=30 g/10 min, 190° C./2.16 kg), Exact 4049 (Exxon, D=0.873 g/cm³, MFI=4.5 g/10 min, 190° C./2.16 kg), Exact 8210 (Exxon, D=0.882 g/cm³, MFI=10 g/10 min, 190° C./2.16 kg), Versify 3401 (Dow Chemicals, D=0.863 g/cm³, MFI=8 g/10 min, 230° C./2.16 kg), Versify 3300 (Dow Chemicals, D=0.866 g/cm³, MFI=8 g/10 min, 230° C./2.16 kg).

However, no polar polymers such as ethylene vinylacetate (EVA), ethylene ethylacrylate (EEA), etc., or mineral fillers in amounts exceeding 5% are needed for the peeling layer. Preferably, less than 1% polar polymers and/or less than 1% mineral fillers, in particular no polar polymers or mineral filers, are contained therein. Moreover, preferably no bonding enhancers are contained therein.

An optional heat-resistant cover layer is based on a homo-polypropylene, nucleated homo-polypropylene or a block-copolymer that can also be nucleated. The melting point in DSC should be above 150° C. The measurement is performed according to DIN ISO 3146.

Another criterion of the invention is that the composite of sheets shows good transparence, i.e. the haze value of a sheet with a thickness of 100 μm measured according to ASTM D1003 is maximally 30%, preferably maximally 20%.

According to another feature, the bonding force between the individual layers of the sheet according to the invention is sufficiently high for no separation of layers to occur between the layers of the top sheet during the process of peeling said top sheet off a substrate.

Moreover, the composition of the peeling layer is formulated such that a peeling composite that provides assured bonding between the top sheet and the substrate during sterilization and use of the packaging can be produced at a heat-sealing temperature below 130° C.

The composite made up of top sheet and substrate is produced by means of heat and pressure. According to the invention, the composition of the peeling layer allows for a sealing window of at least 10° C. in which, regardless of the substrate used, a peeling force of 0.8 to 3 N/cm, preferably of 1 to 2.8 N/cm, is attained.

The sheet according to the invention can be supplied with antioxidants, UV stabilizers, UV absorbers, lubricants, anti-blocking agent or other additives and extrusion aids in all of its layers. However, it is preferable for no additives to be contained therein.

The composite made up of sheet according to the invention and substrate can be sterilized by means of common sterilization procedures, such as, e.g., gamma irradiation, electron beam procedure, plasma sterilization, steam sterilization at 121° C. or exposure to gas, e.g. using ethylene oxide.

The special feature of the invention is the combination of raw materials. On the one hand, part of the formulation of the peeling layer undergoes bonding with the substrate under the sealing conditions. Another part of the formulation is responsible for bonding to the main layer, but simultaneously is an interfering site for the bonding to the substrate. This component does not attain bonding to the substrate material under the sealing conditions. Special attention was directed in this context to using no inorganic additives with an adverse effect on the good visual properties. A highly transparent sheet can be produced such that the packaged goods can be recognized without impediment. Proper selection of the polypropylene allows a sufficiently stiff sheet to be produced even at low sheet thickness values without having to resort to highly stiff PET or PA layers as is the case with other sheets.

The component that is responsible for bonding to the substrate materials in the peeling layer is a polyolefin plastomer or polyolefin elastomer having a density of 0.85 g/cm³ to 0.89 g/cm³. The melting index measured according to ISO 1133 can be between 0.5 and 30 g/10 min (190° C./2.16 kg).

The polypropylene component in the peeling layer is characterized in that it preferably has a melting point in the range of 100 to 150° C. The melting index can be in the range of 0.5 to 20 g/10 min (230° C./2.16 kg). Especially copolymers of propylene and ethylene or propylene and ethylene and butene can be used as polypropylene, whereby the comonomer fraction preferably is 2 wt-% or more.

Typical representatives include Adsyl 5Q39F (Lyondellbasell, MFI=0.9 g/10 min, 230° C./2.16 kg), Adsyl 5C30F (Lyondellbasell, MFI=5.5 g/10 min, 230° C./2.16 kg), Adflex X 100 G (Lyondellbasell, MFI=8.0 g/10 min, 230° C./2.16 kg), Adflex Q 100 F (Lyondellbasell, MFI=0.8 g/10 min, 230° C./2.16 kg), Hifax CA 138 A (Lyondellbasell, MFI=2.8 g/10 min, 230° C./2.16 kg), RE 809 CF (Borealis, MFI=6.0 g/10 min, 230° C./2.16 kg), TD 218 CF (Borealis, MFI=6.0 g/10 min, 230° C./2.16 kg), TD 109 CF (Borealis, MFI=6.0 g/10 min, 230° C./2.16 kg), RD 204 CF (Borealis, MFI=8.0 g/10 min, 230° C./2.16 kg).

The use of polyethylene from the group of the LLDPEs (linear low density polyethylenes) having a density of 0.90 to 0.935 g/cm³ or LDPEs (low density polyethylenes) having a density of 0.915 to 0.935 g/cm³ together with a polypropylene, as proposed in the prior art, leads to unsatisfactory peeling properties. Typical representatives of the LLDPEs include: Attane 4607G (Dow Chemicals, D=0.904 g/cm³, MFI=4 g/10 min, 190° C./2.16 kg), Attane 4101G (Dow Chemicals, D=0.912 g/cm³, MFI=1 g/10 min, 190° C./2.16 kg), Attane 2045G (Dow Chemicals, D=0.92 g/cm³, MFI=1 g/10 min, 190° C./2.16 kg), Dowlex SC2107 G (Dow Chemicals, D=0.917 g/cm³, MFI=2.3 g/10 min, 190° C./2.16 kg), Dowlex SC2108 G (Dow Chemicals, D=0.935 g/cm³, MFI=2.5 g/10 min, 190° C./2.16 kg). Typical representatives of the LDPEs include: 320 E (Dow Chemicals, D=0.925 g/cm³, MFI=1 g/10 min, 190° C./2.16 kg), 525 E (Dow Chemicals, D=0.932 g/cm³, MFI=3.2 g/10 min, 190° C./2.16 kg). In case of the mixture of LDPE and PP, delamination may occur between the peeling layer and the main layer during a peeling process. Mixtures containing from 30% to 80% LLDPE of a density in excess of 0.9 g/cm³ and/or LDPE with 20% to 80% PP either yielded no adhesive bonding or the adhesive force increased so strongly over 5° C. of temperature increase of the heat-sealing equipment that one can no longer speak of peeling force. Rather, what was attained was permanent heat-seal, i.e. fibers were clearly torn out upon separation from the substrate.

It is absolutely surprising that combining polyolefins according to the invention can be used to attain very good peeling results for paper and synthetic paper even though the chemical nature of these two substrates is totally different. The peeling forces in this context allow the top sheet to be peeled off the substrate without tearing out fibers. The compositions of the individual layers produce a very good clear sheet. Haze values of less than 20% are attained for a 100 μm sheet.

The cover layer that is present in a preferred development that is based on a high-melting polypropylene provides, amongst other features, thermal protection preventing the sheet from sticking to the sealing tool. Polypropylenes, preferably homopolymers thereof, for this application have a melting temperature in DSC of at least 150° C. Typical examples include HD 601 CF (Borealis, MFI=8.0 g/10 min, 230° C./2.16 kg), PP 527 K (Sabic, MFI=3.0 g/10 min, 230° C./2.16 kg), PP 500 P (Sabic, MFI=3.1 g/10 min, 230° C./2.16 kg), BC 918 CF (Borealis, MFI=3.0 g/10 min, 230° C./2.16 kg), HD 905 CF (Borealis, MFI=6.5 g/10 min, 230° C./2.16 kg).

The following layer thickness values have proven to be particularly well-suited: peeling layer 5 to 30 μm, main layer 30 to 300 μm, cover layer, if present, 5 to 30 μm.

Said layers may just as well be made up of multiple individual layers. In order to be able to adjust certain additional functions of the sheet, it is conceivable for the structure to consist of multiple main layers and/or cover layers.

All layers of the sheet can be provided with processing aids and additives. For example, antioxidants, lubricants, anti-blocking agents, UV stabilizers or UV absorbers are thus added. The upper limit of the additional quantity of these additives each is 7 wt-%, preferably 5 wt-% each.

The invention shall be illustrated in more detail by means of the following examples and figures though without limitation to the specifically described embodiment. Unless specified otherwise, any specification of parts or percent refers to the weight, in case of doubt it refers to the total weight of the composition.

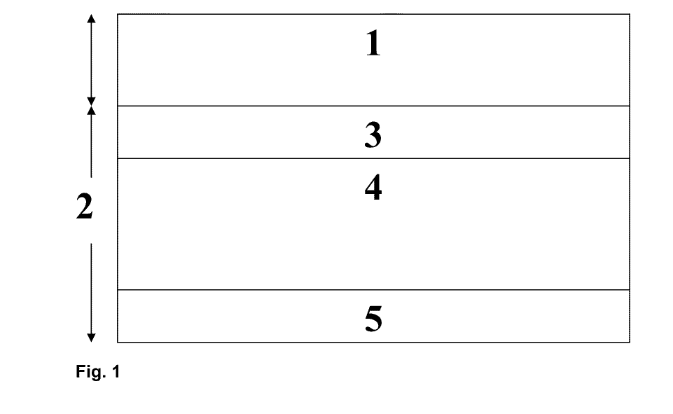

FIG. 1 schematically shows the structure of the peeling composite including the gas-permeable substrate and the polyolefin sheet according to the invention.

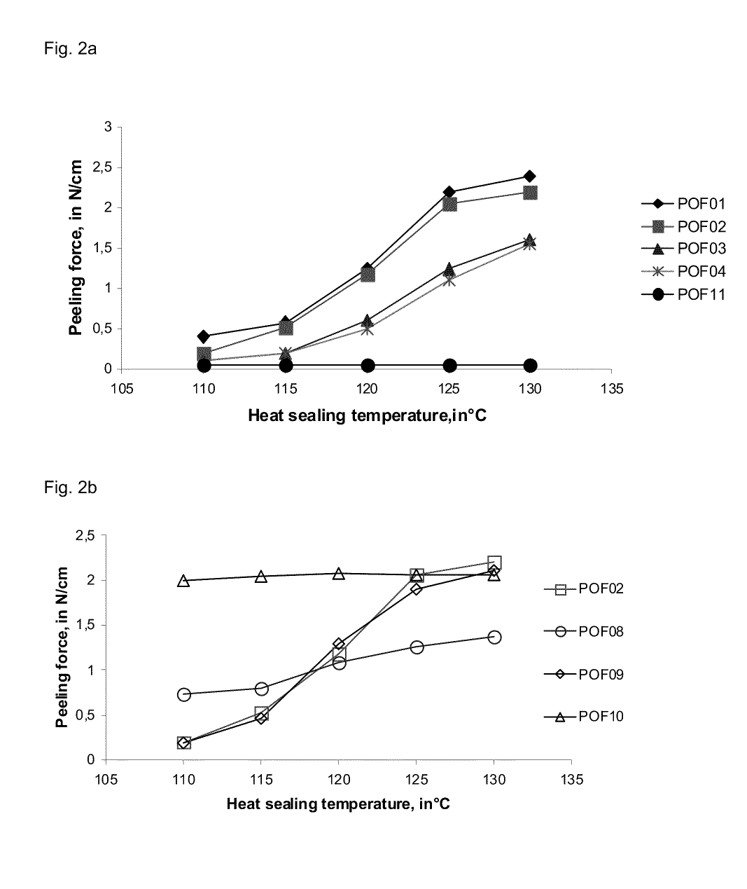

FIGS. 2 a to c show results of a peeling force measurement done on various composites as a function of the heat-sealing temperature.

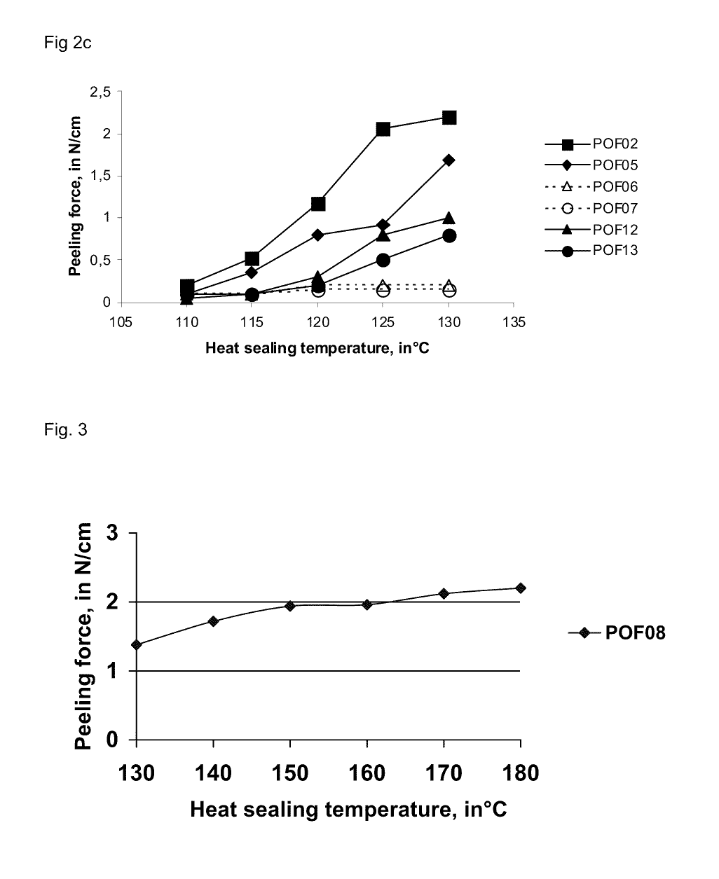

FIG. 3 shows results of a peeling force measurement done on a composite including a sheet according to the invention.

FIG. 1 schematically shows a composite made of top sheet 2 according to the invention and substrate 1. The top sheet comprises a peeling layer 3, a main layer 4, and a cover layer 5.

### EXAMPLE

The formulations specified in Table 1 were used to produce top sheets. Top sheets including LLDPE (PPL2) having densities in excess of 0.9 g/cm³ and LDPE (PPL3) were produced for reasons of comparison. The following polymers were used:

PP1: Polypropylene (copolymer having a melting point of 100 to 150° C.)
PP2: Polypropylene (homopolymer having a melting point of at least 150° C.)
PP3: Polypropylene (copolymer having a melting point of 100 to 150° C.)
PPL1: Polyolefin plastomer having a density of 0.85 to 0.89 g/cm³,

The following base sheets were used as substrates: synthetic paper Tyvek® 1073B (DuPont, article name: SUB1), medical paper MM 60-1 (Vereinigte Papierwerke Feuchtwangen, article name: SUB2), Ovantex® F35 (Oliver, article name: SUB3), and coated synthetic paper CR27—Tyvek® 1073B (PerfecSeal, article name: SUB4).

TABLE 1
Composition of the composite formulations

| | Base | | Main | Cover |
|---|---|---|---|---|
| Composite | sheet | Peeling layer | layer | layer |
| POF01 | SUB 1 | 70 parts by weight PPL1 | PP3 | PP2 |
| | | 30 parts by weight PP1 | | |
| POF02 | SUB 1 | 60 parts by weight PPL1 | PP3 | PP2 |
| | | 40 parts by weight PP1 | | |
| POF03 | SUB 1 | 50 parts by weight PPL1 | PP3 | PP2 |
| | | 50 parts by weight PP1 | | |
| POF04 | SUB 1 | 40 parts by weight PPL1 | PP3 | PP2 |
| | | 60 parts by weight PP1 | | |
| POF05 | SUB 1 | 60 parts by weight PPL1 | PP3 | PP2 |
| | | 40 parts by weight PP2 | | |
| POF06 | SUB 1 | 60 parts by weight PPL2 | PP3 | PP2 |
| | | 40 parts by weight PP1 | | |
| POF07 | SUB 1 | 60 parts by weight PPL3 | PP3 | PP2 |
| | | 40 parts by weight PP1 | | |
| POF08 | SUB 2 | 60 parts by weight PPL1 | PP3 | PP2 |
| | | 40 parts by weight PP1 | | |
| POF09 | SUB 3 | 60 parts by weight PPL1 | PP3 | PP2 |
| | | 40 parts by weight PP1 | | |
| POF10 | SUB 4 | 60 parts by weight PPL1 | PP3 | PP2 |
| | | 40 parts by weight PP1 | | |
| POF11 | SUB 1 | 100 parts by weight PP1 | PP3 | PP2 |
| POF12 | SUB 1 | 30 parts by weight PPL1 | PP3 | PP2 |
| | | 30 parts by weight PPL2 | | |
| | | 40 parts by weight PP1 | | |
| POF13 | SUB 1 | 30 parts by weight PPL1 | PP3 | PP2 |
| | | 30 parts by weight PPL3 | | |
| | | 40 parts by weight PP1 | | |

The top and base sheets were heat-sealed together using a Brugger HSG-C heat-sealing device. The pressure at the sealing jaws was 980 N. The lower sealing jaw consisted of a steel plate coated with a grooved plastic material of Shore A hardness 70. The upper sealing jaw consisted of stainless steel. The sealing area was 0.5×10 cm. The sealing time was 2 seconds. The lower sealing jaw was not heated. The upper sealing jaw was heated.

The peel values were determined 24 hours after heat-sealing. In order to measure the peeling force, the ends of the heat-sealed pieces of the sheets were clamped in a clamping device and the top sheet was pulled off the base sheet at an angle of 180°. The rate was 100 mm/min. The peeling force was obtained from the means of the values measured over a measuring distance of 10 cm. The listed values were converted by calculation for a sealing width of 1 cm.

FIGS. 2 and 3 illustrate the results of the peeling force measurements. It is clearly evident from the figures that only the sheets according to the invention provide the desired peeling forces over a larger range of heat-sealing temperatures. A surprisingly different and unforeseeable peeling behavior as a function of composition is observed.

FIG. 2a shows a comparison of various fractions of plastomer in the top sheet. It is evident that all sheets according to the invention having a plastomer content are useful, whereas an top sheet made of polypropylene that does not include plastomer does not produce a composite.

FIG. 2b compares the behavior of a sheet according to the invention for various substrates and shows that the desired peeling forces are attained with all substrates.

FIG. 2c shows a comparison of various top sheet compositions. All of the sheets according to the invention produce the desired peelable bond, whereas sheets with LDPE having excessively high density or LDPE do not facilitate sufficient bonding to the substrate.

And lastly, FIG. 3 shows that the desired peeling forces are attained over a very wide range of heat-sealing temperatures of 50° C. This allows the sheet according to the invention to provide for assured process control; there is no need to have exact control over the heat-sealing temperature within just a few degrees Celsius as is required by many known sheets.

### LIST OF REFERENCE NUMBERS

1 Substrate
2 Top sheet
3 Peeling layer
4 Main layer
5 Cover layer

1-12. (canceled)

13. Multi-layered sheet for the production of packaging by means of heat-sealing with a substrate made of coated or uncoated paper or synthetic paper, wherein
the sheet comprises a main layer made of polypropylene and a peeling layer containing 30 to 80 wt-% of a polyolefin plastomer having a density of 0.85 to 0.89 g/cm³ and 20 to 70 wt-% of a polypropylene having a melting point in DSC between 100 and 150° C.

14. Sheet according to claim 13, wherein the peeling layer is free of mineral fillers accounting for more than 5 wt-% and/or free of polar polymers.

15. Sheet according to claim 13, wherein the main layer contains at least 70 wt-% of a polypropylene or mixture of propylene copolymers and/or heterophasic propylene copolymers and/or propylene homopolymers.

16. Sheet according to claim 13, wherein the main layer contains a modifier selected from styrene-butadiene-styrene polymers (SBS), styrene-isoprene-styrene polymers (SIS), styrene-ethylene-butylene-styrene polymers (SEBS) and/or styrene-ethylene-propylene-styrene polymers (SEPS).

17. Sheet according to claim 13, wherein the sheet contains a cover layer selected from propylene homopolymer, heterophasic polypropylene and mixtures thereof, whereby the polypropylenes can be nucleated.

18. Sheet according to claim 13, wherein, at 100 μm in thickness, it has a haze value of maximally 20%.

19. Sheet according to claim 13, wherein the peeling force after heat-sealing to the substrate by means of heat and pressure at a maximal heat-sealing temperature of 130° C. is in the range of 0.8 N/cm to 3 N/cm, preferably of 1 to 2.8 N/cm.

20. Composite comprising a sheet according to claim 13, which is heat-sealed to a substrate made of coated or uncoated paper or synthetic paper.

21. Composite according to claim 20, wherein the heat-sealing temperature of a sealing jaw for producing the composite is between 110° C. and 135° C.

22. Composite according to claim 20, wherein it can be sterilized by means of gamma irradiation, electron beam procedure, plasma sterilization, steam sterilization at 121° C. or exposure to gas.

23. Composite according to claim 20, wherein it has a sealing window of at least 10° C., in which a peeling force in the range of 0.8 N/cm to 3 N/cm, preferably of 1 to 2.8 N/cm, is attained independent of the substrate used.

24. Sterilizable packaging such as bags, deep-drawing trays, pouches made from a composite according to claim 20.

25. Sterilizable packaging such as bags, deep-drawing trays, pouches made from a composite according to claim 22.

26. Sheet according to claim 14, wherein the main layer contains at least 70 wt-% of a polypropylene or mixture of propylene copolymers and/or heterophasic propylene copolymers and/or propylene homopolymers.

27. Sheet according to claim 26, wherein the main layer contains a modifier selected from styrene-butadiene-styrene polymers (SBS), styrene-isoprenestyrene polymers (SIS), styrene-ethylene-butylene-styrene polymers (SEBS) and/or styrene-ethylene-propylene-styrene polymers (SEPS).

28. Sheet according to claim 15, wherein the main layer contains a modifier selected from styrene-butadiene-styrene polymers (SBS), styrene-isoprenestyrene polymers (SIS), styrene-ethylene-butylene-styrene polymers (SEBS) and/or styrene-ethylene-propylene-styrene polymers (SEPS).

29. Sheet according to claim 14, wherein the sheet contains a cover layer selected from propylene homopolymer, heterophasic polypropylene and mixtures thereof, whereby the polypropylenes can be nucleated.

30. Sheet according to claim 14, wherein the main layer contains a modifier selected from styrene-butadiene-styrene polymers (SBS), styrene-isoprenestyrene polymers (SIS), styrene-ethylene-butylene-styrene polymers (SEBS) and/or styrene-ethylene-propylene-styrene polymers (SEPS).

31. Sheet according to claim 15, wherein the sheet contains a cover layer selected from propylene homopolymer, heterophasic polypropylene and mixtures thereof, whereby the polypropylenes can be nucleated.

32. Sheet according to claim 16, wherein the sheet contains a cover layer selected from propylene homopolymer, heterophasic polypropylene and mixtures thereof, whereby the polypropylenes can be nucleated.
